(19) United States
(12) Patent Application Publication
(10) Pub. No.: US 2022/0001675 A1
(43) Pub. Date: Jan. 6, 2022

(54) CALCULATIONS OF ESTIMATED THERMAL ENERGY ACCUMULATIONS TO PRINT PIXELS

(71) Applicant: Hewlett-Packard Development Company, L.P., Spring, TX (US)

(72) Inventors: Praveen Boppana, Vancouver, WA (US); Ranjit Bhaskar, Vancouver, WA (US); Jay S. Gondek, Vancouver, WA (US)

(73) Assignee: Hewlett-Packard Development Company, L.P., Spring, TX (US)

(21) Appl. No.: 17/258,469

(22) PCT Filed: Mar. 29, 2019
(86) PCT No.: PCT/US2019/024945

§ 371 Date: Jan. 7, 2021

(51) Int. Cl. B41J 2/36; B41J 2/355; B41J 2/375

(52) U.S. Cl. CPC B41J 2/362; B41J 2/375; B41J 2/3555

(57) ABSTRACT

An example is given of a non-transitory computer-readable medium to store machine-readable instructions to be executed by a controller. The controller controls a heating element to print pixels of an image. The controller calculates an estimated thermal energy accumulation based on control of the heating element. The controller controls the heating element to print subsequent pixels based on the estimated thermal energy accumulation.

### BACKGROUND

Dye sublimation printers may print on a medium using a printhead with heating elements. The printhead may heat up, causing dye or other printing materials to evaporate and be absorbed by or deposited on the medium. The amount of heat generated may affect the amount of dye printed to the medium. For example, when using a yellow dye, a higher heat may result in a darker yellow on the medium.

### BRIEF DESCRIPTION OF THE DRAWINGS

Various examples will be described below referring to the following figures:

FIG. 1 shows a computer-readable medium with machine-readable instructions to control a heating element based on an estimated thermal energy accumulation in accordance with various examples;

FIG. 2 shows an apparatus including a row of heating elements, a controller, and a memory in accordance with various examples;

FIG. 3 shows an example of calculating a short-term thermal energy accumulation and a long-term thermal energy accumulation while printing an image in accordance with various examples; and

FIG. 4 shows a method of calculating an estimated thermal energy accumulation and controlling a heating element based on the estimated thermal energy accumulation, in accordance with various examples.

### DETAILED DESCRIPTION

Dye sublimation printers may experience thermal smear due to thermal energy accumulation. While there may be a delay between printing rows of an image, the delay may be insufficient for the printhead or heating elements to diffuse their heat to the environment. When printing subsequent rows, there may be a thermal energy accumulation based on the printing of prior rows. This may cause subsequent rows to be printed more darkly. For example, when attempting to print a uniform block of color, the later-printed rows may be darker due to the accumulated thermal energy of prior rows being added to the heat generated by the heating elements of the printhead. When transitioning from printing a dark section of an image to a lighter section, the accumulated thermal energy may also cause the initial rows of the lighter section to be printed more darkly, eventually reaching the proper shade of color as the heat diffuses and the heating elements reach a lower temperature.

Calculating an estimated thermal energy accumulation during printing may allow for correction of the heating of heating elements when printing subsequent rows. A long-term thermal energy accumulation and a short-term thermal energy accumulation may be calculated, combined together, and used to modify the amount of heat to be generated by the heating elements. The thermal energy accumulations may be calculated on-the-fly while printing the image. The thermal energy accumulations may use scaled running totals or be based on a select set of data points in order to limit the use of memory and computation time.

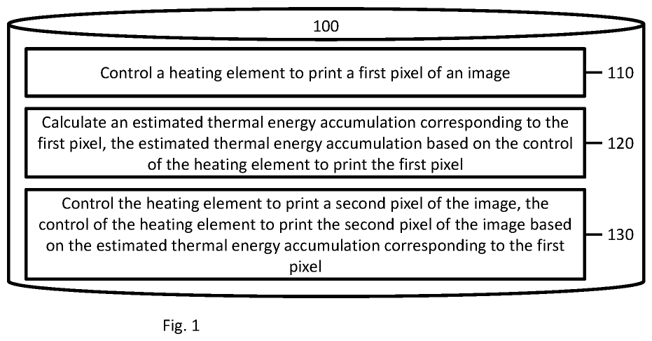

FIG. 1 shows a computer-readable medium 100 with machine-readable instructions 110, 120, 130 to control a heating element based on an estimated thermal energy accumulation in accordance with various examples. Instructions 110, 120, 130 may be for execution by a controller. Instruction 110, when executed by the controller may cause the controller to control a heating element to print a first pixel of an image. Instruction 120, when executed by the controller, may cause the controller to calculate an estimated thermal energy accumulation corresponding to the first pixel, the estimated thermal energy accumulation based on the control of the heating element to print the first pixel. Instruction 130, when executed by the controller, may cause the controller to control the heating element to print a second pixel of the image, the control of the heating element to print the second pixel of the image based on the estimated thermal energy accumulation corresponding to the first pixel.

Heating the heating element may cause evaporation of a dye and absorption of the dye by a medium to print the first pixel. The heating element, printhead, or printing environment may retain thermal energy from the heating of the heating element to print the first pixel. The heat from heating the heating element to print the second pixel may be added to the retained thermal energy, affecting the amount of dye absorbed in printing of the second pixel. The thermal energy may be accumulated after printing the second pixel and affect the printing of subsequent pixels. Such an effect may be corrected by calculating an estimated thermal energy accumulation and controlling the heating element based on the estimated thermal energy accumulation.

In various examples, a heating element may be heated by receiving a pulse wave, the number of pulses controlling the heat generated by the heating element. Based on an accumulated thermal energy in printing the first pixel, the number of pulses sent to the heating element may be adjusted to generate a corrected amount of heat. The adjustment may be to reduce the number of pulses.

In various examples, the number of pulses provided to the heating element may be increased or decreased based on a temperature of the printhead. The printhead may be preheated to reach an operational temperature. The printing may be paused between printing of images to allow dissipation of the temperature. If printing a light image, the number of pulses provided may be increased to account for dissipation of heat that may place the printhead outside an operational temperature range during printing.

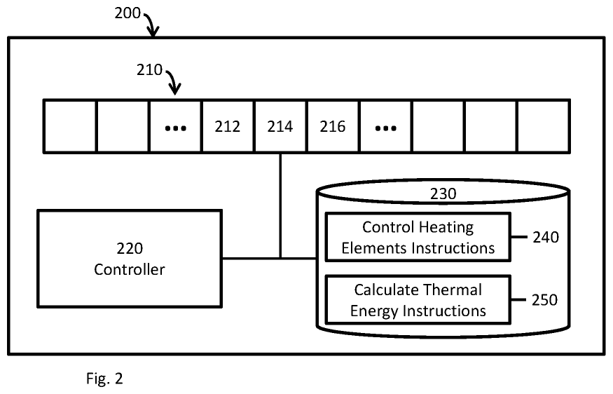

FIG. 2 shows an apparatus 200 including a row of heating elements 210, a controller 220, and a memory 230 in accordance with various examples. The row of heating elements 210 includes a first heating element 212, a second heating element 214, and a third heating element 216. The first heating element 212 is positioned adjacent to the second heating element 214. The third heating element 216 is positioned adjacent to the second heating element 214 opposite the first heating element 212. The first heating element 212, second heating element 214, and third heating element 216 may be positioned in the middle of the row of heating elements 210 or along a side.

The controller 220 may be coupled to the memory 230 and the row of heating elements 210, such as via a bus. The controller 220 may comprise a microprocessor, a microcomputer, a microcontroller, a field programmable gate array (FPGA), or discrete logic. The controller 220 may execute machine-readable instructions that implement the methods described herein.

The memory 230 may include a hard drive, solid state drive (SSD), flash memory, electrically erasable programmable read-only memory (EEPROM), or random access memory (RAM). The memory 230 includes control heating element instructions 240 and calculate thermal energy instructions 250. The calculate thermal energy instructions 250 may cause the processor to calculate an estimated thermal energy accumulation during printing. The control heating element instructions 240 may control the amount of heat generated by the heating elements in the printing process, which may be modified based on the estimated thermal energy accumulation. The instructions 240, 250 may be for execution by the controller 220.

The apparatus 200 may include a dye sublimation printer. The row of heating elements 210 may be part of a printhead. The apparatus 200 may include other elements, such as a motor to move the medium across the printhead, a pump to provide a flow of dye to the printhead, or color ribbons to provide dye for transfer to the medium.

A heating element 212, 214, 216 may include a resistor through which an electrical signal flows to heat up the resistor. The electrical signal may include a voltage pulse wave. When the voltage is high, the resistor may heat up. Control of the number of pulse waves sent to the resistor within a specific duration of time may control the heating of the heating element. A larger number of pulse waves may cause the heating element to generate a higher heat. In various examples, the duty cycle, current value, or voltage value of the pulse wave may be controlled.

In various examples, the apparatus 200 may print using multiple dyes, such as magenta, cyan, yellow, and black dyes. The different colors may be printed using different color ribbons. Different color ribbons may be used to provide different darkness of colors, such as a dark yellow and a light yellow color ribbon, which may improve the range or quality of printed colors. The apparatus 200 may implement a single-pass or multi-pass solution to print using the multiple dyes. The apparatus 200 may include multiple rows of heating elements 210 to print using the different dyes.

Calculating thermal energy accumulation may include calculating a short-term thermal energy accumulation and calculating a long-term thermal energy accumulation, which may be combined. A short-term thermal energy accumulation includes the thermal energy accumulated along a heating element and its adjacent heating elements during printing of the last few rows of pixels. The number of rows of pixels considered may vary with specific implementations. Additional heating elements beyond the directly adjacent heating elements may be considered in estimating a short-term thermal energy accumulation. In various examples, the short-term thermal energy accumulation may consider the directly adjacent heating elements for the last five rows of printed pixels.

A long-term thermal energy accumulation includes one specific heating element and the accumulated thermal energy since beginning the printing of an image. The long-term thermal energy accumulation may be calculated across the printing of multiple images.

In various examples, thermal energy accumulations, including a long-term thermal energy accumulation and a short-term thermal energy accumulation, may be calculated for the various heating elements 212, 214, 216 in the row of heating elements. For example, the long-term thermal energy accumulation for heating element 212 may be different from the long-term thermal energy accumulation for heating element 214, as the heating elements 212, 214 may have been heated by different amounts during printing of an image. While the two heating elements 212, 214 may consider heating of the other heating element 212, 214 as part of calculating the short-term thermal energy accumulation, the thermal energy accumulations may be different and lead to different adjustments in the control of the heating elements 212, 214. This may be because the short-term thermal energy accumulation calculation for heating element 214 accounts for heating of heating element 216, which may not be used to calculate the short-term energy accumulation of heating element 212.

In various examples, apparatus 200 may include a temperature sensor, such as a thermistor. The thermistor may measure an ambient temperature of the environment, a temperature of the medium, a temperature of the printhead, or another temperature related to the printing process. The control of the row of heating elements 210 may be based on the temperature measured by the temperature sensor. The temperature may be used in calculating the accumulated thermal energy, such as modifying the diffusion rate during pauses based on the ambient temperature.

In various examples, the calculation of the thermal energy accumulation may be based on the time between printing rows of pixels. The amount of heat diffused may vary depending on the length time between printing the rows, as there may be a pause in sending pulses to the heating elements of the printhead.

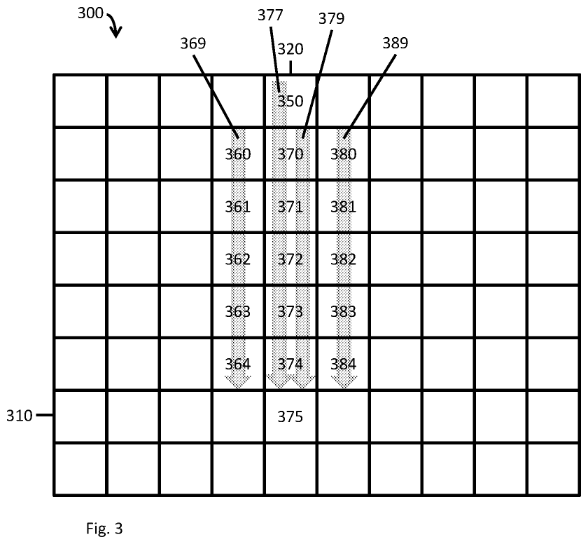

FIG. 3 shows an example of calculating a short-term thermal energy accumulation and a long-term thermal energy accumulation while printing an image 300 in accordance with various examples. The image may be composed of pixels 350, 360, 361, 362, 363, 364, 370, 371, 372, 373, 374, 375, 380, 381, 382, 383, 384. The pixels may be arranged into rows 310 and columns 320. Other arrangements of pixels may be used, such as arrangement in a hexagonal pattern. The heat values used to print pixels 350, 370, 371, 372, 373, 374, under arrow 377 may be used to calculate a long-term thermal energy accumulation prior to printing pixel 375. The heat values used to print pixels 360, 361, 362, 363, 364, 370, 371, 372, 373, 374, 380, 381, 382, 383, 384 under arrows 369, 379, 389 may be used to calculate a short-term thermal energy accumulation prior to printing pixel 375.

The row including pixel 350 may be the first row of an image 300 being printed. The row including pixel 375 may be the current row of the image 300 to be printed. The estimated thermal energy accumulation for the heating element printing column 320 pixels may be calculated. The estimated thermal energy accumulation may include a long-term thermal energy accumulation and a short-term thermal energy accumulation.

The long-term thermal energy accumulation may be calculated as indicated by arrow 377. The heat values used in printing pixels 350, 370, 371, 372, 373, 374 may be combined to determine a long-term thermal energy accumulation. The heat values may be based on the number of pulses provided to the heating element or an intensity of the pixel. One example equation for calculation of a long-term thermal energy accumulation may be:

$${T}_{ab} = ( {T}_{a ( b - 1 )} - D ) + \frac{{( I - M )}^{2}}{S}$$

In the equation above showing an example of calculating a long-term thermal energy accumulation, a indicates the column of the pixel to be printed, and b indicates the row of the pixel to be printed. T indicates the long-term thermal energy accumulation at the specified column and row position. D indicates the amount of thermal energy diffusion to the environment based on pauses between sending the pulses to the heating element or between printing the rows of pixels. I indicates the intensity of the pixel being printed at the current position. The intensity may be represented by the number of pulses sent to the heating element. M indicates the midpoint, where the pixel being printed stops absorbing energy from the thermal energy of the printhead and starts adding to the thermal energy of the system. Printing of higher intensities may add exponentially more thermal energy accumulation. For example, when the intensity is represented as an 8-bit number indicating the number of pulses sent to the heating element, the midpoint may be the value 128, for half the potential number of pulses. Depending on the particular printer, the M value used may differ from half the number of pulses, as the printing may begin adding thermal energy at a higher or lower number of pulses. The M value may be determined empirically through testing. The M value may be determined as part of a calibration or self-calibration procedure. S indicates a scaling factor to be used.

Using such an equation, the long-term thermal energy accumulation for a specific heating element may be stored as one number and updated as the pixels are printed. Tracking the long-term thermal energy accumulations across a row of 1,256 heating elements may use 1,256 numbers. For example, before printing pixel 350, the long-term thermal energy accumulation may be zero, as no prior pixels were printed in the image 300. After printing pixel 350, the long-term thermal energy accumulation may be calculated based on the intensity (I) and midpoint (M) of pixel 350 and the scaling factor. Absent a prior printed row of pixels, the long-term accumulated thermal energy for this heating element from the prior row (T_{a(b-1)}) and the amount of diffusion (D) may be considered zero. After printing pixel 370, the long-term thermal energy accumulation may be calculated by using the long-term thermal energy accumulation calculated after printing pixel 350 as the long-term thermal energy accumulation for the prior row (T_{a(b-1)}). The intensity (I) and midpoint (M) values for pixel 370 may be used to finish the equation, resulting in an updated long-term thermal energy accumulation. This produces a running, scaled average of the thermal energy added by the printing of pixels by a specific heating element. Thus, the long-term thermal energy accumulation prior to printing pixel 375 may be based on the thermal energy accumulated from the prior printing of pixels 350, 370, 371, 372, 373, 374 by the specific heating element.

In various examples, corner cases may be handled, such as if the image 300 includes light sections, so that the thermal energy diffusion (D) is able to sufficiently diffuse the long-term thermal energy accumulation, comparable to the calculations for pixel 350, where there may not be a long-term thermal energy accumulation from a prior row.

In various examples, the intensity (I) and midpoint (M) values may be based on the number of pulses to be provided in printing a pixel. These values may be scaled as appropriate.

The short-term thermal energy accumulation may be calculated by combining the thermal energy accumulated from printing of the last five pixels 370, 371, 372, 373, 374 by the specific heating element and the last five pixels 360, 361, 362, 363, 364, 380, 381, 382, 383, 384 printed by its neighboring heating elements. This may be due to bleed effects as the heat generated by one heating element bleeds over to its neighboring heating elements. This can be seen in FIG. 3 by the arrows 369, 379, 389 indicating pixels over which a short-term thermal energy accumulation may be calculated.

One example equation for calculating a short-term thermal energy accumulation may be:

$$T = {\sum }_{1}^{5} {{S}_{n} ( {I}_{( a - 1 ) ( b - n )} - M )}^{2} + {\sum }_{1}^{5} {{S}_{n} ( {I}_{( a ) ( b - n )} - M )}^{2} + {\sum }_{1}^{5} {{S}_{n} ( {I}_{( a + 1 ) ( b - n )} - M )}^{2}$$

In the equation above, T indicates the short-term thermal energy accumulation, a indicates the column of the pixel to be printed, and b indicates the row of the pixel to be printed. Σ indicates a summation, in this case from 1 to 5 to do a scaled average based on the intensities of the five recently printed pixels for a particular column. M indicates the midpoint. I indicates the intensity of the pixel printed at the column and row position. Sₙ indicates a scaling factor. The scaling factor may be different for the different prior rows of pixels, giving more weight to recently printed pixels. The scaling factor may also be different for the three summations.

Using the above short-term thermal energy accumulation equation as an example, the short-term thermal energy accumulation may be calculated by adding together a scaled average of the five most-recently printed pixels 360, 361, 362, 363, 364 in the column to the left, a scaled average of the five most-recently printed pixels 370, 371, 372, 373, 374 in the current column, and a scaled average of the five most-recently printed pixels 380, 381, 382, 383, 384 in the column to the right.

In various examples, a larger or smaller number of recently printed pixels may be used. For example, one set of pixels from the prior row may be used, instead of sets of pixels from the five prior rows.

The long-term thermal accumulation and short-term thermal accumulation may be scaled and added together into an estimated thermal accumulation. The number of pulses to send to the heating element to print pixel 375 may be adjusted based on the estimated thermal accumulation.

In various examples, the intensity of the pixel to be printed may be modified based on the short-term thermal energy accumulation. For example, an equation such as the following equation may be used:

I_{modified}=I−(Aₐ₋₁−M)S₁−(Aₐ−M)S₂−(Aₐ₊₁−M)S₃

In the equation above, I_{modified} indicates a modified intensity value to use in printing the pixel 375. I indicates the original intensity value for printing the pixel 375. A indicates a moving average of the thermal energy accumulation from printing the last few pixels for a specific column, where Aₐ is the column containing pixel 375, and Aₐ₋₁ and Aₐ₊₁ are for the columns to either side. S indicates scaling factors that may be used, which may be different for the different columns. For example, S₂ for the column containing pixel 375 may be weighted more heavily. M indicates a modification for the midpoints of the printed pixels. I_{modified} may be modified by the calculated long-term thermal energy accumulation, or I_{modified} may be converted into a pulse wave or number of pulses, that is modified by the long-term thermal energy accumulation.

While certain variables, such as I, S, and M were used in the different equations, their values may be different in the different equations. For example, the M may be different for calculating the intensity, as it is accounting for a running average of multiple pixels, while it may account for one pixel when calculating the short-term thermal energy accumulation. The specific equations mentioned here are examples to assist with the explanation, and other equations may be used or may be more convenient in calculating the intensities or thermal energy accumulations.

In various examples, the thermal energy accumulations, including short-term and long term accumulations, may be updated during the printing process. For example, after printing pixels 360, 370, 380 the thermal energy accumulations may be calculated or updated for the respective heating elements. After printing pixels 361, 371, 381, the thermal energy accumulations may be calculated or updated again for the respective heating elements. This may be performed as the rows of pixels are printed in order to correct printing of the next row of pixels based on the accumulated thermal energy at various heating elements. The thermal energy accumulations may be updated based on the prior thermal energy accumulations and the number of pulses provided as new pixels are printed.

Calculating the estimated thermal energy after this fashion may utilize less memory or computation power than other methods. The long-term thermal energy accumulation may use one data value for a heating element that is kept current during the printing process. The short-term thermal energy accumulations may store five data values for a heating element, or some other number of prior pixels, as the data values may be shared with neighboring heating elements.

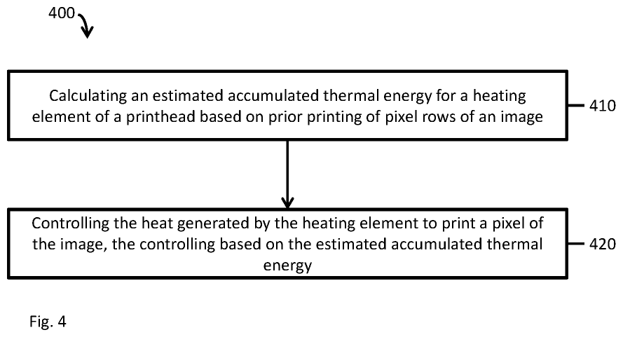

FIG. 4 shows a method 400 of calculating an estimated thermal energy accumulation and controlling a heating element based on the estimated thermal energy accumulation, in accordance with various examples. The method 400 includes calculating an estimated accumulated thermal energy for a heating element of a printhead based on prior printing of pixel rows of an image (410). The method includes controlling the heat generated by the heating element to print a pixel of the image, the controlling based on the estimated accumulated thermal energy (420).

Calculating the estimated thermal energy accumulation may include calculating a short-term accumulated thermal energy and a long-term accumulated thermal energy. The long-term accumulated thermal energy may be based on a running, scaled average indicating the heat generated by a heating element when printing prior pixel rows of the image. The long-term accumulated thermal energy may include thermal energy accumulated across images, such as when images are printed back-to-back.

The short-term accumulated thermal energy calculations may include calculating a scaled average indicating the heat generated by a heating element and additional heating elements on either side. The short-term accumulated thermal energy calculation may calculate such a scaled average for the last row or printed pixels or for a larger number of rows.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A non-transitory computer-readable medium to store machine-readable instructions that, when executed by a controller, cause the controller to:
control a heating element to print a first pixel of an image;
calculate an estimated thermal energy accumulation corresponding to the first pixel, the estimated thermal energy accumulation based on the control of the heating element to print the first pixel; and
control the heating element to print a second pixel of the image, the control of the heating element to print the second pixel of the image based on the estimated thermal energy accumulation corresponding to the first pixel.

2. The non-transitory computer-readable medium of claim 1, wherein the estimated thermal energy accumulation includes an estimated long-term thermal energy accumulation and an estimated short-term thermal energy accumulation.

3. The non-transitory computer-readable medium of claim 1, wherein to control the heating element to print the first pixel, the controller is caused to provide the heating element a number of pulses, the number of pulses corresponding to an amount of heat.

4. The non-transitory computer-readable medium of claim 2, wherein execution of the instructions by the controller causes the controller to calculate a second estimated thermal energy accumulation corresponding to the second pixel by calculating a scaled average based on the estimated thermal energy accumulation and the number of pulses.

5. The non-transitory computer-readable medium of claim 1, wherein an estimated short-term thermal energy component of the estimated thermal energy accumulation is based on a first heat value, a second heat value, and a third heat value, the first heat value indicating a first heat to be generated by the heating element in printing the first pixel, the second heat value indicating a second heat to be generated by a second heating element in printing a third pixel, the third heat value indicating a third heat to be generated by a third heating element in printing a fourth pixel, the second heating element adjacent to the heating element, and the third heating element adjacent to the heating element on a side opposite the second heating element.

6. An apparatus comprising:
a row of heating elements, including a first heating element, a second heating element, and a third heating element, the second heating element positioned between the first heating element and the third heating element;
a controller to control the row of heating elements; and
a memory to store machine-readable instructions to be executed by the controller, wherein the instructions, when executed by the controller, cause the controller to:
control the row of heating elements to print a first row of pixels, including control of the first heating element to generate a first heat, control of the second heating element to generate a second heat, and control of the third heating element to generate a third heat; and
calculate a thermal energy accumulation for the second heating element based on the first heat, the second heat, and the third heat.

7. The apparatus of claim 6, wherein execution of the instructions by the controller causes the controller to:
control the row of heating elements to print a second row of pixels, including control of the first heating element to generate a fourth heat, control of the second heating element to generate a fifth heat, and control of the third heating element to generate a sixth heat, the control of the second heating element based on the thermal energy accumulation; and
calculate a second thermal energy accumulation based on the thermal energy accumulation, the fourth heat, the fifth heat, and the sixth heat.

8. The apparatus of claim 7, wherein the calculation of the second thermal energy accumulation is based on a time between the printing of the first row of pixels and the printing of the second row of pixels.

9. The apparatus of claim 7, wherein the calculation of the second thermal energy accumulation includes calculating a long-term thermal energy accumulation and calculating a short-term thermal energy accumulation, the long-term thermal energy accumulation based on the second heat and the fifth heat, and the short-term thermal energy accumulation based on the fourth heat, the fifth heat, and the sixth heat.

10. The apparatus of claim 6 comprising a temperature sensor to measure a temperature, wherein the control of the row of heating elements to print the first row of pixels is based on the temperature.

11. A method comprising:
calculating an estimated accumulated thermal energy for a heating element of a printhead based on prior printing of pixel rows of an image; and
controlling the heat generated by the heating element to print a pixel of the image, the controlling based on the estimated accumulated thermal energy.

12. The method of claim 11 wherein calculating an estimated accumulated thermal energy includes calculating a short-term accumulated thermal energy and calculating a long-term accumulated thermal energy.

13. The method of claim 12, wherein calculating the long-term accumulated thermal energy includes calculating a running scaled average indicating heat generated by the heating element during the prior printing of pixel rows of the image.

14. The method of claim 12, wherein calculating the short-term accumulated thermal energy includes calculating a scaled average indicating heat generated by the heating element, a second heating element, and a third heating element in printing a prior pixel row of the image, the heating element positioned between the second heating element and the third heating element.

15. The method of claim 11 comprising measuring a temperature via a temperature sensor, wherein the controlling of the heat is based on the temperature.
